(19) United States
(12) Patent Application Publication
(10) Pub. No.: US 2003/0074452 A1
(43) Pub. Date: Apr. 17, 2003

(54) System and method of determining QoS establishment mode

(75) Inventors: Haihong Zheng, Coppell, TX (US); Stefano Faccin, Dallas, TX (US)

Correspondence Address: COHEN, PONTANI, LIEBERMAN & PAVANE, Suite 1210, 551 Fifth Avenue, New York, NY, 10176, US

(73) Assignee: Nokia Corporation

(21) Appl. No.: 09/975,203

(22) Filed: Oct. 11, 2001

(51) Int. Cl. G06F 15/16; G06F 15/173

(52) U.S. Cl. 709/228; 709/242; 709/235

(57) ABSTRACT

A system and method for determining which of a user node and an IP network will establish Quality of Service (QoS). The IP network transmits a message indicating whether the IP network, the user node, or both the IP network and the user node are capable of establishing QoS. If only the IP network or the user node can establish QoS, then it is done in that manner. If either can establish QoS, the user node may select which entity will establish QoS.

### BACKGROUND OF THE INVENTION

1. Field of the Invention

The present invention relates generally to communication networks using the Internet Protocol (IP), and, more particularly, to a system and method of allowing an IP terminal node to select a Quality of Service (QoS) establishment model in an IP network.

2. Description of the Related Art

The invention of the telephone opened an unprecedented era in personal communication. Similarly, in the past decade, the Internet has opened up another era in personal communication, allowing a level of interactivity previously unknown between human beings, computers and communication devices. Presently, these two services (Internet and telephone) are being combined into one seamless communication medium.

However, the concepts respectively underlying the telephone system and the Internet are fundamentally different. The telephone system is circuit-based, meaning that, for example, when a call is set up between caller and callee, a dedicated line, or circuit is maintained between the two and, when the call is over, the dedicated line is taken down. The Internet is packet-based, meaning that, for example, when a user downloads a web page or receives an e-mail, the data that comprises the web page or e-mail is broken down into packets before being transmitted. The individual packets, although they together form one web page or one e-mail message, may follow or traverse entirely different routes between the sender and the destination. The destination computer puts all of the individual packets together to form the web page.

A fundamental problem lies in providing a circuit-based service, such as a telephone call or videoconference, over a packet-based network. While the answer may appear simple—i.e., digitize and packetize the audio or visual information—the situation is more complex than first appears. For one thing, an application such as a telephone call requires a constant transmission rate, something that the current Internet cannot guarantee. An application such as videoconferencing has stringent real-time requirements to keep the displayed motion from appearing jerky. These requirements include a variable transmission rate and very little jitter in the packet arrival times. At present the Internet cannot guarantee that these requirements will be met.

The term in current use for the provision of guaranteed service levels is Quality of Service (QoS). There are a variety of solutions that have been offered to provide QoS on an IP network: class-based architectures, such as DiffServ (RFC 2475), IntServ (RFC 1633), and MPLS (RFC 3031), as well as per-call setups, such as RSVP (RFC 2205). Because of the fluid and constantly expanding nature of Internet protocols and technology, the various QoS solutions are continually growing and evolving, and many of them have begun to overlap.

Regardless of which QoS solution is used (or even if several QoS solutions are used), there is always the basic question of who establishes the QoS parameters across the network for each session (a “session” is a more general term than “call” and can apply to a telephone call, a videoconference, a game, a multimedia session, a chat session, etc.). Although the nature of the session itself—whether it is for voice or video, high-quality or low-quality—determines what type of QoS will be requested, there is still the process of actually provisioning, or establishing, QoS for the session. There are two QoS establishment modes: node-establishing (where the IP node initiating the session arranges QoS) and network-establishing (where a network node arranges QoS). Each QoS solution assumes one of these modes.

To clarify the differences between the two establishment modes, an example of each is described below.

An example of a QoS system in node-establishing mode is the DiffServ system shown in FIG. 1. In a DiffServ system, packet traffic shaping is implemented by network routers. To specify the transmission requirements, DiffServ uses the Type of Service (ToS) bits in the IP packet header. Although the field exists in the current protocol IPv4 (Internet Protocol, version 4), most routers do not use or read the bits in this field. DiffServ uses these bits to tell the router the priority of the packet. Consequently, this field in the IP header is referred to as the DS field.

When packet traffic enters a DiffServ network, the packets are classified and possibly conditioned at the network boundary, most likely in an edge router. The DS field will be filled in with the appropriate bits for that type of traffic, which may depend on customer usage, media specification, general policy, etc. The network nodes inside the DiffServ network will read the DS field to determine how to manage incoming packets. For instance, if an edge router recognizes incoming packets as being high priority, the router will classify those packets as high priority in the DS field, and then send those packets inside the network. When those high priority packets reach a network node, the node will forward them before other packets because the DS field indicates that they are high priority. This example is somewhat of a simplification, for the DS field classification scheme is more complex than mere high or low priority and takes into account throughput, delay, jitter, packet loss, and other traffic characteristics.

In FIG. 1, Bandwidth Broker 120 controls the classification of packets at network node 130. An application 110 running on User Node 105 requires QoS for a particular communication session 140 with a callee. User Node 105 can be any device capable of running an application and establishing communications over an IP network, e.g., a wireline telephone, a mobile telephone, a Portable Digital Assistant (PDA), a laptop computer, etc. User Node 105 explicitly sends a QoS request 150 through Network Node 130 to Bandwidth Broker 120. The protocol used for this communication is unimportant for the understanding of the present invention and so will not be specified; however, the protocol could be RSVP with certain modifications or perhaps a protocol written precisely for this purpose. Bandwidth Broker 120 responds at 155 to User Node 105 and controls network node 130 to classify the packets for the session of application 110 with the appropriate QoS that User Node 105 and Bandwidth Broker 120 have established. In a 3GPP network, Bandwidth Broker 120 would be the GGSN (Gateway GPRS (General Packet Radio Service) Servicing/Support Node) and QoS request 150 is the PDP (Packet Data Protocol) context activation or modification request.

An example of a QoS system in the network-establishing mode is the system depicted in FIG. 2. As there shown, User Node 205 uses the Session Initiation Protocol (SIP) to initiate a session. The SIP protocol is a text-based application-layer protocol that works above the transport layer in the TCP/IP (Transport Control Protocol/Internet Protocol) stack. SIP can use any transport protocol, including TCP (Transport Control Protocol) and UDP (User Datagram Protocol) as its transport protocol. In addition, SIP can also work with ATM AAL5 (Asynchronous Transfer Mode ATM Adaption Layer 5), IPX (Internet Packet eXchange), frame relay or X.25 transport protocols.

There are two components in SIP: network servers and user agents. A user agent is an end system that acts on behalf of someone who wants to participate in calls or sessions. In general, the user agent contains both a protocol client (a user agent client—UAC 201) which initiates a call and a protocol server (user agent server—UAS 220) which responds to a call. There are two also different types of network servers: a proxy server, which receives requests, determines which server to send it to, and then forwards the request; and a redirect server, which receives requests, but instead of forwarding them to the next hop server, tells the client to contact the next hop directly.

The steps in initiating a session are fairly straightforward: as shown in FIG. 2, (1) the UAC 201 sends an INVITE request to SIP server 210, which in this case, is a proxy server. The SIP server 210 will look in its database to determine where to send the INVITE request. Once that is determined, the proxy server sends (2) the INVITE message to the appropriate next hop. In FIG. 2, the next hop is the callee (UAS 220) but, in reality, there could be a number of hops between the SIP server and the callee. If the SIP server 210 was a redirect server, it would inform the UAC as to the appropriate next hop, and let the UAC do the rest. Once the INVITE message finally reaches the callee UAS 220, the callee UAS 220 responds (3) with an OK message, which is received by SIP server 210. At this point, SIP server 210 sends (4) a QoS request to Bandwidth Broker 230 on behalf of User Node 205. The QoS parameters were taken from the original INVITE message. After Bandwidth Broker 230 sets up QoS, it sends (5) a QoS reply to SIP server 210, which now forwards (6) the OK message to User Node 205. If the system is unable to provide the requested QoS, another message would be transmitted. Once the caller UAC 201 receives the OK message, indicating that callee UAS 220 has received the INVITE and that QoS has been established, the UAC 201 sends (7) an ACK message which, when received (8) by callee 220, will start the session.

In current networks, only a single establishment mode is deployed. Furthermore, current IP nodes only support one establishment mode. This becomes problematic when IP nodes are mobile, and thus travel between networks. Further still, future networks will be capable of supporting both establishment modes.

Therefore, there is a need for a system and method that will enable an IP node to use a network which supports both establishment modes. There is also a need for a system and method that will allow an IP node to recognize whether one or both establishment modes are available in a given network. Furthermore, there is a need for a system and method that allows an IP node to choose which establishment mode to use in a network capable of both establishment modes.

### SUMMARY OF THE INVENTION

One object of the present invention is to provide a system and method in which an IP network can communicate its capabilities with respect to establishment modes.

Another object of the present invention is to provide a system and method in which an IP node may receive establishment mode options from an IP network, and then indicate a choice of establishment mode to the IP network.

To accomplish these and other objects, the present invention provides a system and method for determining whether the user node or the IP network itself will establish Quality of Service (QoS). In the system and method, the IP network transmits a message indicating whether the IP network, the user node, or both the IP network and the user node are capable of establishing QoS. If only the IP network or the user node can establish QoS, then it is done in that manner. If either can establish QoS, the user node may select which entity will establish QoS.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 depicts a prior art IP network in which a user node establishes QoS;

FIG. 2 depicts a prior art IP network in which the IP network establishes QoS;

FIG. 3 depicts the functional modules in a prior art Mobile IPv4 network;

FIG. 4A shows the fields in the Mobility Agent Advertisement Extension used in prior art Mobile IPv4 advertisement messages;

FIG. 4B shows the fields in a Mobility Agent Advertisement Extension used in Mobile IPv4 advertisement messages according to the first exemplary embodiment of the present invention;

FIG. 5A shows the fields in a prior art Mobile IPv4 Registration Request;

FIG. 5B shows the fields in a Mobile IPv4 Registration Request according to the first exemplary embodiment of the present invention;

FIG. 6A shows the fields in a prior art Mobile IPv4 Registration Reply; and

FIG. 6B shows the fields in a Mobile IPv4 Registration Reply according to the second exemplary embodiment of the present invention.

### DETAILED DESCRIPTION OF THE PRESENTLY PREFERRED EMBODIMENTS

The system and method of the present invention can be broken down into two parts: (1) how the network tells the IP node what its establishment modes are; and (2) how a IP node tells the network which establishment mode it prefers.

For the first part, there are a wide variety of ways that the network can provide establishment mode information, as will become clear from the following three exemplary embodiments. However, the present invention is in no way limited to these examples, and is intended to cover other possible embodiments. The IP network can tell the IP node what establishment modes are supported 1) by using broadcast information messages, such as layer 2 broadcasting or router advertisements, 2) during the registration process, or 3) during service establishment. Likewise, for the second part, the IP node can tell the network which establishment mode it prefers 1) by responding to network broadcast information messages, 2) during the registration process, or 3) during service establishment. The only requirement is that the second part follows the first part. Thus, if the network sends its establishment mode information during the registration process (first part), the IP node can indicate its establishment mode preference (second part) only during the registration process or during service establishment, but not by responding to broadcast information messages.

The three exemplary embodiments show the variety of protocols and messages that may be used when implementing the present invention. The first exemplary embodiment is in a mobile network, where the network communicates the possible modes with a broadcast advertisement message and the IP node indicates its preference with a registration request message. In the second exemplary embodiment, which is also a mobile network, the IP network communicates the possible modes in a Mobile IP registration reply message and the IP node chooses the preferred mode in a SIP registration message. The third exemplary embodiment has an IP network that is not necessarily a mobile network using a SIP registration reply (OK) message to communicate the possible modes and the IP node choosing the preferred mode in a SIP session set-up message.

In the first exemplary embodiment, in which the supported establishment mode information is sent in a broadcast message, an agent advertisement message in Mobile IP is modified to carry flags conveying the establishment mode information. This exemplary embodiment assumes a mobile network environment, but the present invention may work in any network environment, such as an Ethernet LAN or a wireless LAN (WLAN). Thus, other embodiments might modify other network broadcast messages, such as a IPv4 or IPv6 Router Advertisement, in order to tell the user node what establishment modes are supported by the network. Furthermore, other layers may be used to make these announcements, such as the radio layer in a wireless network, or layer 2 in an Ethernet LAN.

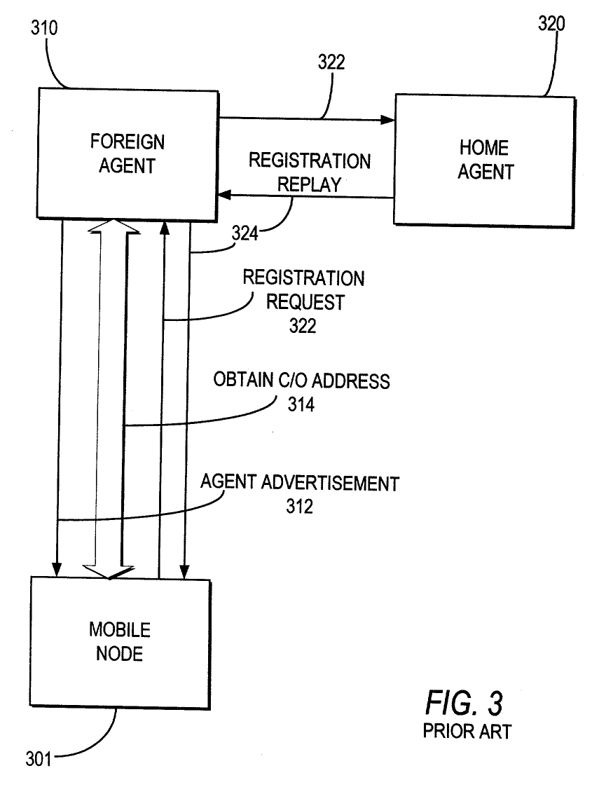

The first exemplary embodiment uses Mobile IPv4, as described in Internet Draft “IP Mobility Support for IPv4, revised”, published Sep. 19, 2001. Mobile IPv4 will be briefly described in reference to FIG. 3. As there shown, there are three basic functional units in Mobile IPv4: the Mobile Node 301, the Foreign Agent 310, and the Home Agent 320. The Agents (for “Mobility Agents”) are routers in different networks. Home Agent 320 is a router on Mobile Node 301's home network (where Mobile Node 301 has a long term IP address). Home Agent 320 maintains current location information for Mobile Node 301 and, when Mobile Node 301 is outside of the home network, Home Agent 320 forwards (or “tunnels”) communication packets intended for Mobile Node 301 to Mobile Node 301's current location. Foreign Agent 320 is a router in a network which Mobile Node 301 is temporarily visiting and Foreign Agent 320 provides routing services to Mobile Node 301 while Mobile Node 301 is registered in Foreign Agent 320's network.

After arriving in Foreign Agent 310's network area, Mobile Node 301 receives an Agent Advertisement 312 from Foreign Agent 310. Agent Advertisement 312 is a broadcast message advertising Foreign Agent 310's services and may either be regularly transmitted or prompted by a Mobile Node. Mobile Node 301 realizes it is away from home by the contents of Agent Advertisement 312, and then obtains a “care-of” IP address 314 for use by Mobile Node 301 while it is using Foreign Agent 310's services. After obtaining its care-of address, Mobile Node 301 registers it with Home Agent 320 by sending a Registration Request 322, which is processed by Foreign Agent 310 before being forwarded to Home Agent 320. Then Home Agent 320 sends a Registration Reply 324, which is processed by Foreign Agent 310 before being forwarded to Mobile Node 301. If registration was successful, a node communicating with Mobile Node 301 would send packets to Home Agent 320 which would tunnel them to Mobile Node 301's care-of address. In other words, the entire process would be transparent to the communicating node.

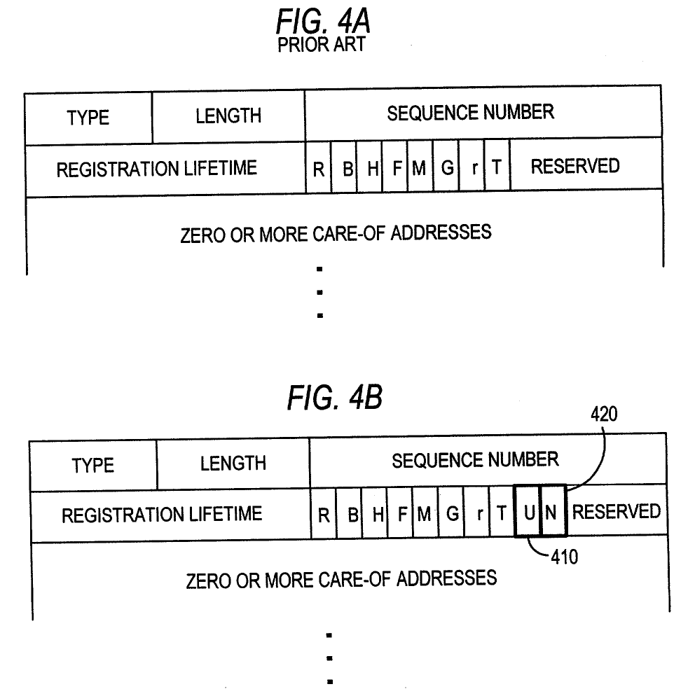

In the first exemplary embodiment, Agent Advertisement 312 is used to inform Mobile Node 301 what establishment modes are supported in Foreign Agent 310's network. Agent Advertisement 312 is formed by extending the ICMP (internet Message Control Protocol, RFC 793) Router Advertisement message from ICMP Router Discovery Messages (RFC 1256). Mobile IPv4 adds a Mobility Agent Advertisement Extension after the ICMP Router Advertisement fields. The fields of a prior art Mobility Agent Advertising Extension are shown in FIG. 4A. Since they are not directly relevant to this embodiment, they will not be described. As shown in FIG. 4B, two fields (U 410 and N 420) for indicating the establishment mode capabilities of the mobility agent are added in the first exemplary embodiment of the present invention.

In FIG. 4B, the U (user) field indicates whether the Mobile Node 301 can establish the QoS parameters, whereas the N (network) field indicates whether Foreign Agent 310's network can establish the QoS parameters. Table 1 shows what the binary values of those fields denotes:

TABLE 1

| U | N | Capabilities supported by the network |
|---|---|---|
| 0 | 1 | Only the network-establishing mode is supported |
| 1 | 0 | Only the node-establishing mode is supported |
| 1 | 1 | Both the network- and node-establishing modes are supported |

In the first exemplary embodiment, Mobile Node 301 listens for this broadcast information to determine what establishment modes are available. If only one mode is supported, Mobile Node 301 follows the procedures defined for that mode. If, on the other hand, both modes are supported, Mobile Node 301 is free to indicate which mode it prefers to use for a particular session.

In the first exemplary embodiment, Mobile Node 301 indicates its preference using Registration Request 322. It should be noted, however, that there are many other protocols and/or message types that might be used: e.g., a Mobile IPv6 Binding Update message, a User Registration Protocol (URP) Registration message, a SIP REGISTER message, or a SIP INVITE message. As stated above, the present invention is in no way limited to these examples, as one skilled in the art will recognize that there are many other ways that the IP node could indicate its preference to the network.

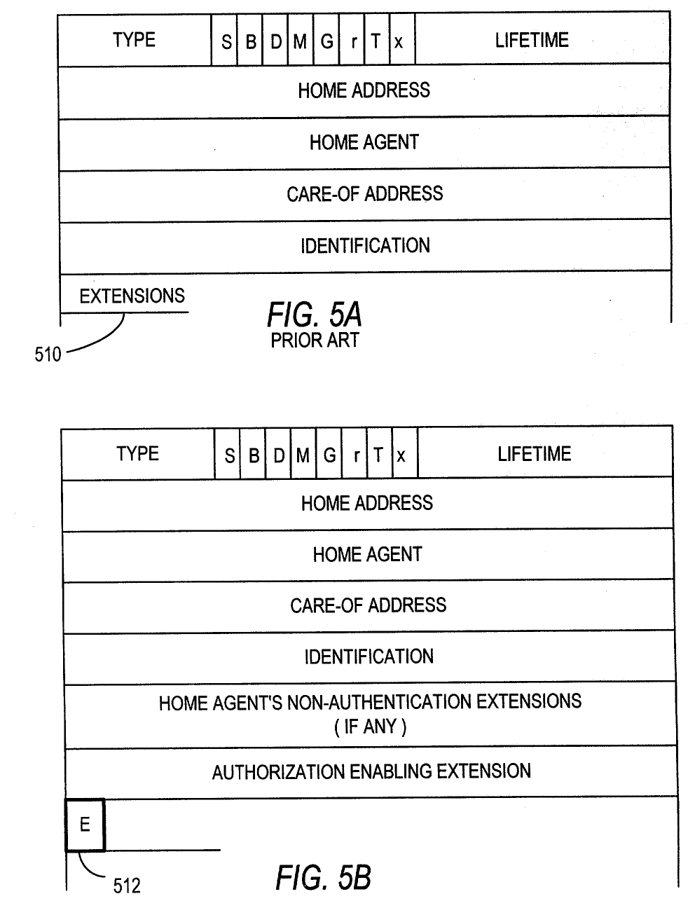

Prior art Registration Request messages use the User Datagram Protocol (UDP) packet format, where the UDP header is followed by Registration Request header, such as shown in FIG. 5A. The header ends with unspecified Extensions 510. These may be many things, but they follow a particular order: 1) if present, non-authentication extensions expected to be used by Home Agent 320; 2) an authorization-enabling extension, which must be present; 3) any non-authentication extensions used only by Foreign Agent 310, if present; and 4) the Mobile-Foreign Authentication extension, if present. In the first exemplary embodiment, an extension, consisting of one field, is placed in the area designating non-authentication extensions used only by Foreign Agent 310. The added extension, field E 515, is shown in FIG. 5B and indicates the preferred establishment mode of Mobile Node 301. Foreign Agent 310 reads field E 512 before relaying Registration Request 322 to Home Agent 320. If Foreign Agent 310's network did not support both establishment modes, field E 515 would be ignored. Table 2 shows what the binary values of field E denotes:

TABLE 2

| E | Establishment Mode preferred by Mobile Node |
|---|---|
| 0 | Network-establishing mode is preferred |
| 1 | Node-establishing mode is preferred |

In the second exemplary embodiment, where the supported establishment mode information is sent during registration, the Registration Reply 324 message in Mobile IPv4 is modified to carry flags conveying the establishment mode information. Although this exemplary embodiment assumes Mobile IPv4, the present invention may use any registration protocol, such as Mobile IPv6 or the possible future protocol URP (User Registration Protocol). The Internet Engineering Task Force (IETF) is currently considering forming a working group (WG) on URP, which would define registration messages between a IP node (which could be mobile or non-mobile) and an IP network. Thus, other embodiments might modify other registration protocol messages, such as the future URP registration reply message or the Mobile IPv6 Binding Acknowledgment, in order to tell the user node what establishment modes are supported by the network.

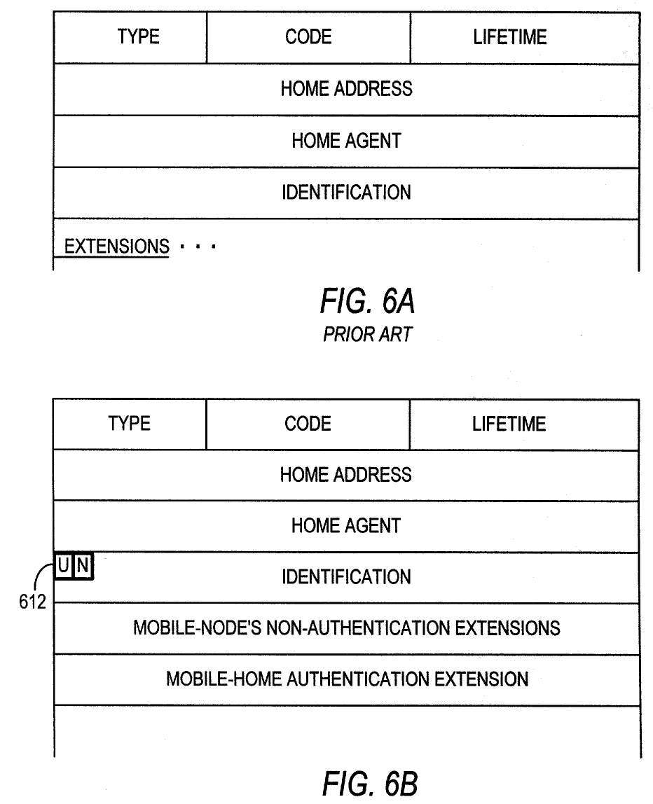

In the second exemplary embodiment, Registration Reply 324 is used to inform Mobile Node 301 what establishment modes are supported in Foreign Agent 310's network. Similarly to Registration Request 322, Registration Reply 324 is formed by adding a Registration Reply header after the UDP header. The prior art Registration Reply header is shown in FIG. 6A. The header ends with unspecified Extensions 610. Like Registration Request 322, these extensions may be many things, but they follow a particular order: 1) if present, non-authentication extensions to be used by Mobile Node 301; 2) the Mobile-Home Authentication extension, which must be present; 3) any non-authentication extensions used only by Foreign Agent 310, if present; and 4) the Foreign-Home Authentication extension, if present. In the second exemplary embodiment, an extension, consisting of two fields, is placed by Foreign Agent 310 in the area designating non-authentication extensions used by Mobile Node 301. The added extension is comprised of fields U 610 and U 620, as shown in FIG. 6B, and indicate what establishment modes are supported in Foreign Agent 310's network.

In FIG. 6B, the U (user) field indicates whether the Mobile Node 301 can establish the QoS parameters, whereas the N (network) field indicates whether Foreign Agent 310's network can establish the QoS parameters. Table 3 (which is identical to Table 1, although other embodiments may indicate what is supported by other binary values, as well as other fields) shows what the binary values of those fields denotes:

TABLE 3

| U | N | Capabilities supported by the network |
|---|---|---|
| 0 | 1 | Only the network-establishing mode is supported |
| 1 | 0 | Only the node-establishing mode is supported |
| 1 | 1 | Both the network- and node-establishing modes are supported |

In the second exemplary embodiment, Mobile Node 301 parses these new fields in Registration Reply 324 to determine what establishment modes are available. If only one mode is supported, Mobile Node 301 follows the procedures defined for that mode. If, on the other hand, both modes are supported, Mobile Node 301 is free to indicate which mode it prefers to use for a particular session.

In the second exemplary embodiment, Mobile Node 301 indicates its preference during the SIP registration process. In SIP, the UAC registers (or “logs on”) with the local SIP server using a REGISTER message. If the registration message is authorized, the SIP server responds with an OK message. An example of a REGISTER message and the OK message in response to the REGISTER message is shown below:

REGISTER Message from IP Node to SIP Server

REGISTER sip:ss2.nokia.com SIP/2.0

Via: SIP/2.0/UDP there.com:5060

From: Nomad <sip:UserB@there.com>

To: Nomad <sip:UserB@there.com>

Call-ID: 123456789@here.com

CSeq: 1 REGISTER

Contact: Nomad <sip:UserB@there.com>

Contact: sip:+1-972-555-2222@gw1.nokia.com;user=phone

Contact: tel:+1-972-555-2222

Content-Length: 0

Authorization:Digest username=“UserB”, realm=“Nokia SIP”,

nonce=“ea9c8e88df84f1cec4341ae6cbe5a359”, opaque=“ ”,

uri=“sip:ss2.nokia.com”,

response=“dfe56131d1958046689cd83306477ecc”

Content-Length: 0

OK Message from SIP Server in Response to REGISTER Message from IP Node

SIP/2.0 200 OK

Via: SIP/2.0/UDP there.com:5060

From: Nomad <sip:UserB@there.com>

To: Nomad <sip:UserB@there.com>

Call-ID: 1234567890@here.com

CSeq: 1 REGISTER

Contact: Nomad <sip:UserB@there.com>

Contact: sip:+1-972-555-2222@gw1.nokia.com;user=phone

Contact: tel:+1-972-555-2222

Content-Length: 0

A discussion of all of the fields in the REGISTER message is unnecessary to a description of the second exemplary embodiment of the present invention. In this embodiment, another field is added to the SIP REGISTER message to indicate the IP node's establishment mode preference. As shown highlighted below, the added field is delineated Est-Mode and the possible values are user (for node-establishing mode, which is selected in this example) or network (for network-establishing mode). The name of the field and the names of the field's possible values are only exemplary, as one skilled in the art will recognize.

REGISTER Message from IP Node to SIP Server According to the Second Exemplary Embodiment of the Present Invention

REGISTER sip:ss2.nokia.com SIP/2.0

Via: SIP/2.0/UDP there.com:5060

From: Nomad <sip:UserB@there.com>

To: Nomad <sip:UserB@there.com>

Call-ID: 123456789@here.com

Est-Mode: user

CSeq: 1 REGISTER

Contact: Nomad <sip:UserB@there.com>

Contact: sip:+1-972-555-2222@gwl.nokia.com;user=phone

Contact: tel:+1-972-555-2222

Content-Length: 0

Authorization:Digest username=“UserB”, realm=“Nokia SIP”,

nonce=“ea9c8e88df84f1cec4341ae6cbe5a359”, opaque=“ ”,

uri=“sip:ss2.nokia.com”,

response=“dfe56131d1958046689cd83306477ecc”

Content-Length: 0

In the third exemplary embodiment, where the supported establishment mode information is sent during service set-up, a registration reply message in SIP is modified to carry fields conveying the establishment mode information. Although this exemplary embodiment assumes SIP, the present invention may use any service set-up or establishment protocol, such as H. 323 and the Real Time Streaming Protocol (RTSP). Thus, other embodiments might modify other messages, from other protocols, in order to tell the user node what establishment modes are supported by the network. Furthermore, unlike the first two exemplary embodiments, the third exemplary embodiment is not necessarily a mobile network.

In the third exemplary embodiment, the network provides its capabilities in the OK response to the REGISTER message. In this embodiment of the invention, another field is added to the SIP OK message to indicate the network's establishment mode capabilities. As shown highlighted below, the added field is delineated Est-Mode and the possible values are user (for node-establishing mode only), network (for network-establishing mode), or both (for both modes are possible, which is selected in this example). The name of the field and the names of the field's possible values are only exemplary, as one skilled in the art will recognize.

OK Message from SIP Server in Response to REGISTER Message from the IP Node According to the Third Exemplary Embodiment of the Present Invention

REGISTER sip:ss2.nokia.com SIP/2.0

Via: SIP/2.0/UDP there.com:5060

From: Nomad <sip:UserB@there.com>

To: Nomad <sip:UserB@there.com>

Call-ID: 123456789@here.com

Est-Mode: both

CSeq: 1 REGISTER

Contact: Nomad <sip:UserB@there.com>

Contact: sip:+1-972-555-2222@gw1.nokia.com;user=phone

Contact: tel:+1-972-555-2222

Content-Length: 0

Authorization:Digest username=“UserB”, realm=“Nokia SIP”,

nonce=“ea9c8e88df84f1cec4341ae6cbe5a359”, opaque=“ ”,

uri=“sip:ss2.nokia.com”,

response=“dfe56131d1958046689cd83306477ecc”

Content-Length: 0

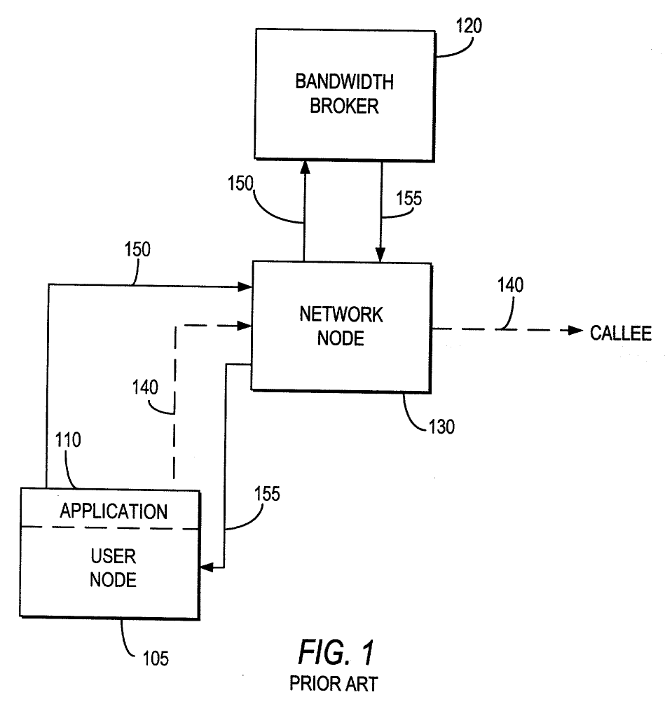

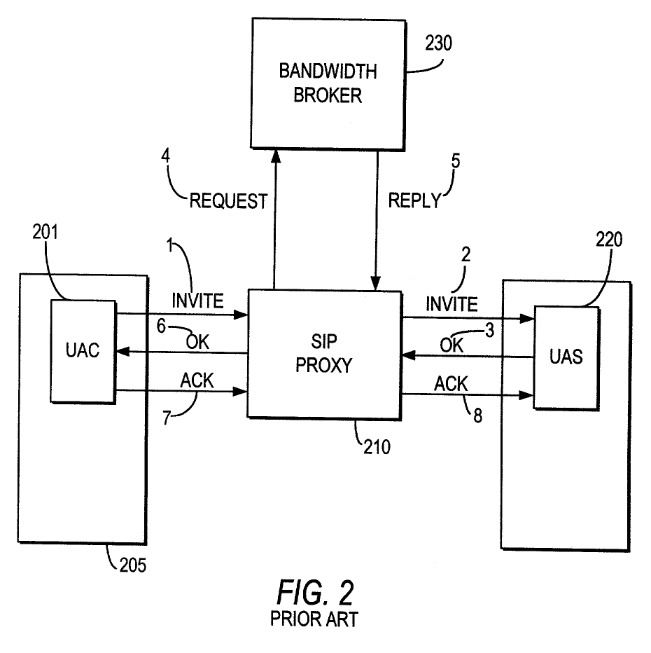

In the third exemplary embodiment, since the network did not provide its capabilities until it sent an OK response to a REGISTER message, the IP node obviously cannot use the REGISTER message to indicate its preference. Thus, in this embodiment of the present invention, another SIP message is needed to implement the second part of the invention. In this case, the INVITE message (as shown in FIGS. 1 and 2) which is used by the IP node to initiate a session could have another field added. A prior art INVITE message is shown below:

INVITE Message from IP Node to SIP Server

INVITE sip:+1-972-555-2222@ss1.wnokia.com;user=phone SIP/2.0

Via: SIP/2.0/UDP here.com:5060

From: Nomad <sip:+1-314-555-1111@ngw1.nokia.com>;user=phone

To: Stillworth <sip:+1-972-555-2222@ss1.nokia.com>;user=phone

Call-Id: 12345600@here.com

CSeq: 1 INVITE

Contact: Nomad <sip:UserA@here.com>

Authorization:Digest username=“UserA”, realm=“Nokia SIP”,

nonce=“ea9c8e88df84f1cec4341ae6cbe5a359”, opaque=“ ”,

uri=“sip:ss1.nokia.com”,

response=“dfe56131d1958046689cd83306477ecc”

Content-Type: application/sdp

Content-Length: 132

v=0

o=UserA 2890844526 2890844526 IN IP4 here.com

t=0 0

c=IN IP4 here.com

m=audio 49170 RTP/AVP 0

a=rtpmap:0 PCMU/8000

Once again, a description of all of the fields is unnecessary to an understanding of the present invention. However, one will note that the bottom fields, as indicated by letters (“v=”, “o=”, etc.) are part of the Session Description Protocol (SDP, RFC 2327) which describes details of the session being set up. Although in this embodiment another field is added to the SIP INVITE message to indicate the network's establishment mode capabilities, an additional field can be added in the SDP section in another embodiment. As shown highlighted below, the added SIP INVITE field is delineated Est-Mode and the possible values are user (for node-establishing mode only), network (for network-establishing mode), or both (where both modes are possible, which is this example). Once again, it should be understood that the indicated name of the field and names of the field's possible values are only exemplary, as those skilled in the art will recognize.

INVITE Message from IP Node to the SIP Server According to the Third Exemplary Embodiment of the Present Invention

INVITE sip:+1-972-555-2222@ss1.wnokia.com;user=phone SIP/2.0

Via: SIP/2.0/UDP here.com:5060

From: Nomad <sip:+1-314-555-1111@ngw1.nokia.com>;user=phone

To: Stillworth <Sip:+1-972-555-2222@ss1.nokia.com>;user=phone

Call-Id: 12345600@here.com

Est-Mode: both

CSeq: 1 INVITE

Contact: Nomad <sip:UserA@here.com>

Authorization:Digest username=“UserA”, realm=“Nokia SIP”,

nonce=“ea9c8e88df84f1cec4341ae6cbe5a359”, opaque=“ ”,

uri=“sip:ss1.nokia.com”,

response=“dfe56131d1958046689cd83306477ecc”

Content-Type: application/sdp

Content-Length: 132

v=0

o=UserA 2890844526 2890844526 IN IP4 here.com

t=0 0

c=IN IP4 here.com

m=audio 49170 RTP/AVP 0

a=rtpmap:0 PCMU/8000

In summary, the present invention provides a method and system that supports both node-establishing and network-establishing modes separately or simultaneously within a network. The invention provides flexibility to service providers because the service providers can select different establishment modes for different application services, even if those services are on the same mobile node. On another level, it is recognized that some service providers prefer different control models, i.e., some like to have tight control of QoS (network-establishing) while others prefer a looser, more distributed control of QoS (node-establishing). In the present invention, the network can determine control by indicating its establishment mode capability. In other words, even if the network is capable of both modes, the network may choose to tell certain IP nodes that it is only capable of one or the other modes. The present invention thus allows a network to maintain a preferred establishment mode, or to tailor the establishment modes of individual IP nodes according to network needs. Furthermore, the present invention enables an IP node to travel from a network capable of only one establishment mode to a network capable of only the other establishment mode.

Thus, while there have shown and described and pointed out fundamental novel features of the invention as applied to preferred embodiments thereof, it will be understood that various omissions and substitutions and changes in the form and details of the methods described and devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of determining which entity in an Internet Protocol (IP) network will establish Quality of Service (QoS), wherein the IP network is comprised of a user node, comprising the steps of:
transmitting, by the IP network, a message indicating which of at least one of the user node and the IP network is capable of establishing QoS; and
selecting, by the user node, one of the IP network and the user node to establish QoS, if the IP network indicates that both the user node and the IP network are capable of establishing QoS.

2. The method as recited in claim 1, wherein the user node is a mobile terminal.

3. The method as recited in claim 1, wherein the message transmitted by the IP network is a broadcast message to any IP node which can receive it.

4. The method as recited in claim 3, wherein the message transmitted by the IP network is a Mobile IPv4 Agent Announcement message, and wherein the Mobile IPv4 Agent Announcement message contains at least one field to indicate which of at least one of the user node and the IP network is capable of establishing QoS.

5. The method as recited in claim 3, wherein the message transmitted by the IP network is a Router Advertisement message , an d wherein the Router Advertisement message contains at least one field to indicate which of at least one of the user node and the IP network is capable of establishing QoS.

6. The method as recited in claim 5, wherein the Router Advertisement message is one of an IPv4 Router Advertisement message and an IPv6 Router Advertisement message.

7. The method as recited in claim 1, wherein the message transmitted by the IP network is a message transmitted during a registration procedure of the user node.

8. The method as recited in claim 7, wherein the message transmitted during the registration procedure of the user node is a Mobile IPv4 Registration Reply message, and wherein the Mobile IP Registration Reply message contains at least one field to indicate which of at least one of the user node and the IP network is capable of establishing QoS.

9. The method as recited in claim 7, wherein the message transmitted during the registration procedure of the user node is a Mobile IPv6 Binding Acknowledgement message, and wherein the Mobile IPv6 Binding Acknowledgement message contains at least one field to indicate which of at least one of the user node and the IP network is capable of establishing QoS.

10. The method as recited in claim 7, wherein the message transmitted during the registration procedure of the user node is a Session Initiation Protocol (SIP) OK message in response to a SIP REGISTER message transmitted by the user node, and wherein the OK message contains at least one field to indicate which of at least one of the user node and the IP network is capable of establishing QoS.

11. The method as recited in claim 1, wherein the message transmitted by the IP network is a message transmitted during a session setup procedure.

12. The method as recited in claim 1, wherein the step of selecting, by the user node, one of the IP network and the user node to establish QoS, comprises:
transmitting, by the user node to the IP network, a message selecting one of the user node and the IP network to establish QoS.

13. The method as recited in claim 12, wherein the message transmitted by the user node is a message transmitted during a registration procedure of the user node.

14. The method as recited in claim 13, wherein the message transmitted during the registration procedure of the user node is a Registration Request message, and wherein the Registration Request message contains at least one field selecting one of the user node and the IP network to establish QoS.

15. The method as recited in claim 14, wherein the Registration Request message is one of a Mobile IPv4 Registration Request message, a Mobile IPv6 Binding Request message, and a User Registration Protocol (URP) registration message.

16. The method as recited in claim 13, wherein the message transmitted during the registration procedure of the user node is a Session Initiation Protocol (SIP) REGISTER message, and wherein the REGISTER message contains at least one field to select one of the user node and the IP network to establish QoS.

17. The method as recited in claim 12, wherein the message transmitted by the user node is a message transmitted during a session setup procedure of the user node.

18. The method as recited in claim 17, wherein the message transmitted during the session setup procedure of the user node is a Session Initiation Protocol (SIP) INVITE message, and wherein the INVITE message contains at least one field to select one of the user node and the IP network to establish QoS.

19. A system for determining which entity in an Internet Protocol (IP) network will establish Quality of Service (QoS), comprising the steps of:
a user node; and
an IP network for transmitting a message indicating which of at least one of the user node and the IP network is capable of establishing QoS;
wherein the user node is operable for selecting one of the IP network and the user node to establish QoS, if the IP network indicates in the transmitted message that both the user node and IP network are capable of establishing QoS.

20. The system as recited in claim 19, wherein the user node is a mobile terminal.

21. The system as recited in claim 20, wherein the mobile terminal is one of a cellular telephone, a Personal Digital Assistant (PDA), and a laptop computer.

22. The system as recited in claim 19, wherein the IP network is a wireless broadcast network.

23. The system as recited in claim 19, wherein the IP network message is one of a IP Router Advertisement message, Mobile IP Agent Announcement message, a User Registration Protocol (URP) registration message, and a Mobile IP Registration Reply message, and wherein the IP network message has at least one field which indicates which of at least one of the user node and the IP network is capable of establishing QoS.

24. The system as recited in claim 19, wherein the IP network message is a Session Initiation Protocol (SIP) OK message in response to a SIP REGISTER message transmitted by the user node, and wherein the SIP OK message contains at least one field to indicate which of at least one of the user node and the IP network is capable of establishing QoS.

25. The system as recited in claim 19, wherein the user node indicates the selection by means of a selection message to the IP network.

26. The system as recited in claim 25, wherein the selection message is a message transmitted during one of a registration procedure of the user node and a session setup procedure of the user node.

27. The system as recited in claim 25, wherein the selection message is one of a SIP REGISTER message and a SIP INVITE message, and wherein the selection message contains at least one field for selecting one of the user node and the IP network.

28. The system as recited in claim 25, wherein the selection message is a Mobile IPv4 Registration Request message, a Mobile IPv6 Binding Update message, a User Registration Protocol (URP) registration message, and wherein the selection message contains at least one field for selecting one of the user node and the IP network to establish QoS.
